(19) United States
(12) Patent Application Publication
(10) Pub. No.: US 2007/0202835 A1
(43) Pub. Date: Aug. 30, 2007

(54) Power saving method for a wireless communication apparatus

(75) Inventors: Jung-Je Son, Seongnam-si (KR); Yeong-Moon Son, Anyang-si (KR); Hyoung-Kyu Lim, Seoul (KR); Pan-Yuh Joo, Seoul (KR); Jae-Weon Cho, Suwon-si (KR); Bong-Seok Jang, Jeollanam-do (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/701,243

(22) Filed: Feb. 1, 2007

(30) Foreign Application Priority Data
Feb. 1, 2006 (KR) 9867/2006

(51) Int. Cl. G08C 17/00; H04B 1/16

(52) U.S. Cl. 455/343.1; 370/311

(57) ABSTRACT

Disclosed is a power saving method for a wireless communication apparatus that operates in a sleep mode during a predetermined duration by exchanging Media Access Control (MAC) messages with a base station in order to reduce power consumption when there is no transmission/reception data. According to the power saving method, switching is made between the sleep mode and a normal mode by transmission data generated by an upper layer. In the power saving method, an active mode switching is performed by recognizing the start and end of data transmission/reception in the upper layer, thereby preventing unnecessary power consumption caused by a listening interval of a fixed length.

### PRIORITY

This application claims priority under 35 U.S.C. §119(a) to an application filed in the Korean Intellectual Property Office on Feb. 1, 2006 and assigned Serial No. 2006-9867, the contents of which are incorporated herein by reference.

### BACKGROUND OF THE INVENTION

1. Field of the Invention

The present invention relates generally to a wireless communication system, and in particular, to a power saving method for a wireless communication apparatus based on the transmission/reception status of upper-layer data.

2. Description of the Related Art

Institute of Electrical and Electronics Engineers (IEEE) 802.16e is a portable Internet standard amended to add support for mobility of terminals to IEEE 802.16. Thus, IEEE 802.16e describes a power saving mechanism, such as a sleep mode, for minimizing the power consumption of mobile terminals.

A power saving mode refers to a state in which data transmission/reception is not performed through prior agreement between a terminal and a base station. The power saving mode is useful for both the terminal and the base station because of minimizing the power consumption of the terminal and reducing the use of wireless resources.

IEEE 802.16e classifies packet traffics according to two power saving class types according to the characteristics of the packet traffics. In other words, a non-real-time packet traffic that is insensitive to delay is classified as a traffic type 1 and a real-time packet traffic that is sensitive to delay is classified as a traffic type 3.

In a connection for the traffic type 1, to enter the power saving mode, a terminal transmits a sleep request (MOB_SLP_REQ) message to a base station. Upon receipt of a sleep response (MOB_SLP_RSP) message from the base station, the terminal goes into the power saving mode by referring to parameters included in the MOB_SLP_RSP message, such as listening interval information and sleep interval information, thereby reducing power consumption. During a periodically generated listening interval, the terminal determines whether there is reception data by referring to a traffic indication (MOB_TRF_IND) message transmitted from the base station. If there is no reception data, the terminal increases the sleep interval to twice as long as the previous sleep interval. If there is reception data, the terminal leaves the power saving mode and receives the data.

FIG. 1 is a ladder type diagram illustrating a message flow for implementing a power saving mode in the current IEEE 802.16e standard.

In FIG. 1, a Media Access Control (MAC) layer of a terminal 10, delivered from an upper layer, actuates a timer if there is no data stored in a buffer, and determines whether transmission data is input until the timer expires. If any transmission data is not input until the expiration of the timer, the MAC layer transmits a MOB_SLP_REQ message to a base station 20 and the base station 20 having received the MOB_SLP_REQ message determines whether there is transmission data in a transmission buffer for the terminal 10. If there is no transmission data in the transmission buffer, the base station 20 generates and then transmits a MOB_SLP_RSP message to the terminal 10. The MOB_SLP_RSP message includes listening interval information and sleep interval information, and the terminal 10 enters a listening mode and a sleep mode based on the listening interval information and the sleep interval information.

However, both the sleep interval and the listening interval are fixed in the power saving mechanism of the current IEEE 802.16e standard. Thus, even if receiving the MOB_SLP_RSP message during the listening interval, the terminal goes into the sleep mode after the end of the listening interval. As a result, power may be wasted between the reception of the MOB_SLP_RSP message and the end of the listening interval at which the terminal actually enters the sleep mode.

### SUMMARY OF THE INVENTION

An object of the present invention is to address at least the above described problems and/or disadvantages and to provide at least the advantages described below. Accordingly, an object of the present invention is to provide a power saving method, by which a terminal actively initiates entry into a sleep mode by recognizing the actual start and end of transmission/reception in an upper layer, thereby, minimizing power consumption.

Another object of the present invention is to provide a power saving method, by which a terminal in a sleep mode enters a normal mode upon generation of transmission data in an upper layer whether sleep mode duration expire, thereby minimizing processing delay.

Another further object of the present invention is to provide a power saving method, by which a terminal in a normal mode switches to a sleep mode without staying in a listening mode of fixed time, if any transmission data is not input from an upper layer during a predetermined period of time, thereby minimizing power consumption.

According to an aspect of the present invention, there is provided a power saving method implemented in a wireless communication apparatus that operates in a sleep mode during a predetermined duration by exchanging Media Access Control (MAC) messages with a base station in order to reduce power consumption when there is no transmission/reception data. According to the power saving method, switching is made between the sleep mode and a normal mode according to the data transmission status of an upper layer.

### BRIEF DESCRIPTION OF THE DRAWINGS

The above and other features and advantages of the present invention will become more apparent from the following detailed description when taken in conjunction with the accompanying drawings in which:

FIG. 1 is a ladder-type diagram illustrating a message flow for implementing a power saving mode in the current Institute of Electrical and Electronics Engineers (IEEE) 802.16e standard;

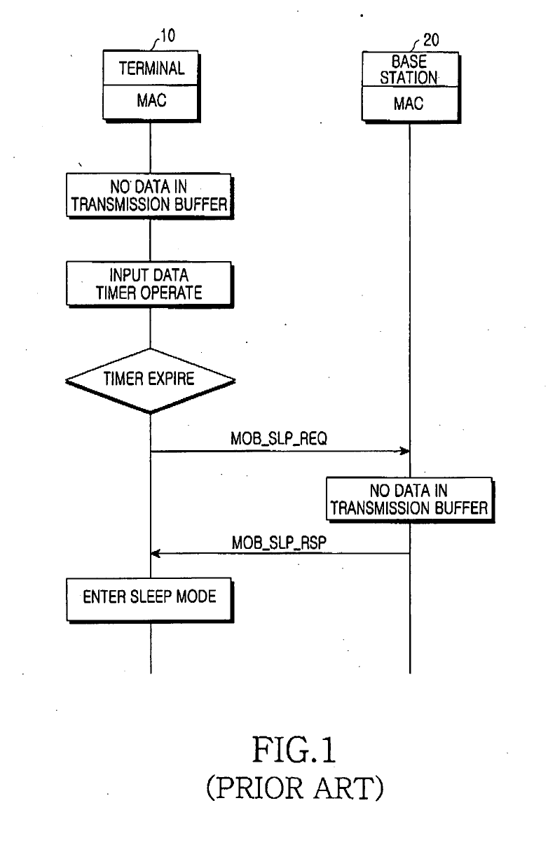

FIG. 2 is a state transition diagram illustrating each layer of a wireless communication apparatus for explaining a power saving method according to the present invention; and

FIG. 3 is a ladder-type diagram illustrating a message flow for explaining a power saving method according to the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

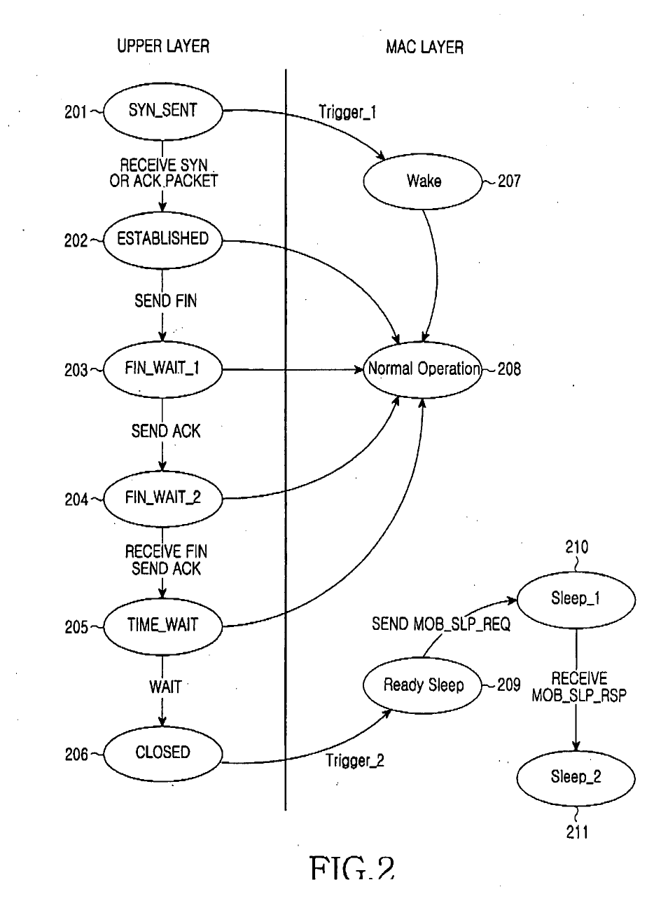

FIG. 2 is a state transition diagram illustrating each layer of a wireless communication apparatus for explaining a power saving method according to the present invention. For convenience of explanation, a wireless terminal will be taken as an example of the wireless communication apparatus.

Referring to FIG. 2, upon activation of the wireless terminal, a Transmission Control Protocol (TCP) layer transmits a SYNchronization (SYN) packet and enters a synchronization transmitted (SYN_TRANSMITTED) state 201 to wait for one of a SYN packet and an ACKnowledgement (ACK) packet.

Upon reception of one of the SYN packet and the ACK packet, the TCP layer transmits the ACK packet and establishes a connection with a base station to enter a communication established (ESTABLISHED) state 202

If there is no data to be transmitted to the base station in the ESTABLISHED state 202, the TCP layer transmits a connection finalization request (FIN) packet and enters a finalization wait (FIN_WAIT_1) state 203 to wait for an ACK packet. Upon reception of the ACK packet in response to the FIN packet, the TCP layer re-enters a finalization wait (FIN_WAIT_2) state 204 to wait for a FIN packet from the base station. When receiving the FIN packet from the base station, the TCP layer enters a time wait (TIME_WAIT) state 205 to wait during the time sufficient for the base station to receive the ACK packet and then enters a closed (CLOSED) state 206 to close the connection.

A Media Access Control (MAC) layer wakes up by the SYN packet generated in the TCP layer and transmits a Bandwidth Request (BR) message to the base station.

The MAC layer is activated by a first trigger (TRIGGER_1) during the transmission of the SYN packet and enters a wake (WAKE) state 207. The MAC layer activated by the first trigger generates and transmits a BR message having an uplink sleep control signal header. The MAC layer having woken up by the first trigger stays in a normal operation (NORMAL OPERATION) state 208 in such states of the TCP layer as the ESTABLISHED state, the FIN_WAIT_1 state, the FIN_WAIT_2 state, the TIME_WAIT state, and the like. At the end of the connection with the TCP layer, the MAC layer enters a ready-to-sleep (READY TO SLEEP) state 209 by a second trigger (TRIGGER_2). In other words, when the second trigger is generated, the MAC layer transmits the MOB_SLP_REQ message to the base station and switches to a first sleep (SLEEP_1) mode 210 from an active mode. Upon the expiration of the first sleep mode, the MAC layer receives the MOB_SLP_RSP message in response to the MOB_SLP_REQ message and enters a second sleep (SLEEP_2) mode 211. The first sleep mode interval may be set to be shorter than round trip time and if the round trip time is short, the execution of the first sleep mode may be skipped. The second sleep mode interval may be determined by sleep mode information included in the MOB_SLP_RSP message.

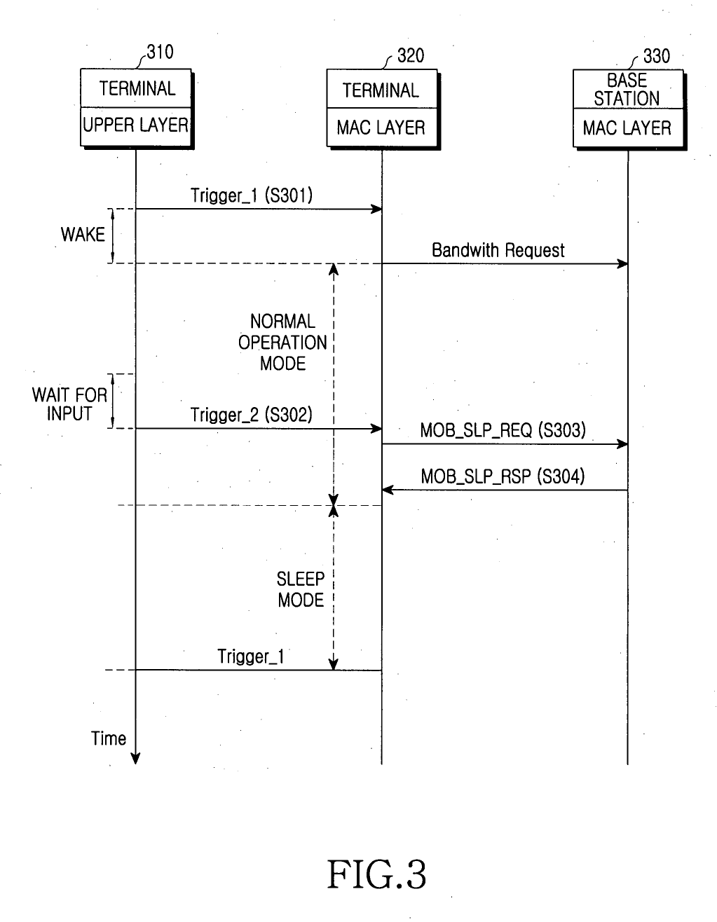

FIG. 3 is a ladder-type diagram illustrating a message flow for explaining a power saving method according to the present invention.

In a power saving method for a wireless communication system according to the present invention, a MAC layer of a terminal wakes up to the normal mode or enters the sleep mode by a trigger from an upper layer.

When transmission data is generated in an upper layer 310, the upper layer 310 of the terminal delivers a wake trigger (TRIGGER_1) to a MAC layer 320 in step S301 and the MAC layer 320 leaves the sleep mode by the wake trigger. After waking up from the sleep mode, the terminal transmits a bandwidth request message to the base station to be allocated resources and transmits/receives data using the allocated resources.

If transmission data is not input to a transmission buffer during a predetermined period of time, i.e., a sliding window, the upper layer 310 of the terminal generates a sleep mode entry trigger (TRIGGER_2) and transmits the sleep mode entry trigger to the MAC layer 320 in step S302.

Upon generation of the sleep mode entry trigger, the MAC layer 320 of the terminal transmits the MOB_SLP_REQ message to a base station 330 in step S303. When receiving the MOB_SLP_RSP message from the MAC layer 330 of the base station in response to the MOB_SLP_REQ message in step S304, the terminal enters the sleep mode.

The sleep mode duration may be determined by sleep mode information included in the MOB_SLP_RSP message. If transmission data is not generated from the upper layer 310 during the sleep mode duration, the terminal checks if there is data to be received from the base station upon the expiration of the sleep mode duration.

If there is data to be received from the base station, the terminal enters the normal mode by the wake trigger. If there is no data to be received from the base station, the terminal returns to the sleep mode.

According to the present invention, active mode switching is made by recognizing the start and end of data transmission/reception in an upper layer, thereby preventing unnecessary power consumption caused by a listening interval of a fixed length.

While the invention has been shown and described with reference to a preferred embodiment thereof, it will be understood by those skilled in the art that various changes in form and details may be made therein without departing from the spirit and scope of the invention as defined by the appended claims.

What is claimed is:

1. A power saving method for a wireless communication apparatus that operates in a sleep mode during a predetermined duration by exchanging Media Access Control (MAC) messages with a base station when there is no transmission/reception data for reducing power consumption, the power saving method comprising:
recognizing a data transmission status of an upper layer; and
switching to one of a normal mode and a sleep mode according to the data transmission status of the upper layer.

2. The power saving method of claim 1, wherein the switching comprises:
determining whether a current mode is one of the normal mode and the sleep mode;
observing whether transmission data is generated from the upper layer, if the current mode is the sleep mode; and
switching to the normal mode, if the transmission data is generated.

3. The power saving method of claim 2, wherein the switching comprises:
determining whether the predetermined duration time expires, if transmission data is not generated; and
switching to the normal mode, if the predetermined duration expires.

4. The power saving method of claim 1, wherein the switching comprises:
determining whether transmission data is input from the upper layer during a predetermined time window, if the current mode is the normal mode; and
switching to the sleep mode, if the transmission data is not input.

5. The power saving method of claim 4, wherein the switching to the sleep mode comprises:
transmitting a sleep request message to a base station if the transmission data is not input; and
switching to the sleep mode if a sleep response message is received in response to the sleep request message.
